(19) United States
(12) Patent Application Publication
(10) Pub. No.: US 2026/0152651 A1
(43) Pub. Date: Jun. 4, 2026

(54) NON-FLUORINATED HYDROPHOBIC AND OLEOPHOBIC COATING COMPOUNDS FOR OPTICAL TRANSPARENT SURFACES AND METHODS OF USING THE SAME

(71) Applicant: Brizon, Inc., Escondido, CA (US)

(72) Inventor: Geoffrey Yuxin Hu, San Diego, CA (US)

(73) Assignee: Brizon, Inc., Escondido, CA (US)

(21) Appl. No.: 18/964,293

(22) Filed: Nov. 29, 2024

(51) Int. Cl. C09D 7/65; B05D 3/02; C09D 5/02; C09D 7/20; C09D 183/04

(52) U.S. Cl. CPC C09D 7/65; B05D 3/0254; C09D 5/022; C09D 7/20; C09D 183/04

(57) ABSTRACT

A non-fluorinated hydrophobic and oleophobic coating and method for applying to optical transparent materials (OTMs) is disclosed, wherein the hydrophobic and oleophobic coating is a compound formed from at least one solvent with a hydroxy group, at least one alkyl siloxane/silane compound as a hydrophobic agent, and at least one siloxane and/or silane with an active hydrogen bond donor as an oleophobic agent. The coating provides better surface cosmetics and more effective protection from environmental insults.

### BACKGROUND

### Field of the Invention

This invention relates to coatings for optical transparent materials, and more specifically to non-fluorinated hydrophobic and oleophobic compounds for coating optical transparent materials.

### Description of Related Art

Optical transparent materials (OTMs) include inorganic materials such as glass, quartz, sapphire, etc., and organic materials such as polycarbonates, polyurethanes, CR-39, Trivex, et al. They are widely used for eyeglass lenses, smartphone surfaces, vehicle displays, and even structural surfaces such as concrete, granite, etc. Coatings are often applied to these materials to provide anti-fingerprint properties to keep surfaces clean and smudge-free.

Existing coatings primarily utilize fluorinated materials, or hydrofluorocarbons (HFCs), such as 2-(perfluorahexyl)ethyl triethoxysilane. The HFC coatings are often used to prevent fingerprints from impacting the display on a mobile device; the so-called “anti-fingerprint properties.” The HFC coatings can minimize the appearance of fingerprints and also serve as a barrier to gases, moisture, oil and other liquids. The coatings also provide surface protection from scuffing, abrasion and scratching. HFC coatings generally have very good chemical resistance and enjoy wide use in these areas.

However, the American Innovation and Manufacturing (AIM) Act of 2020, 42 USC 7675, requires the US Environmental Protection Agency (EPA) to reduce or eliminate the use of HFCs by 2036, primarily due to their harmful effects as greenhouse gases. It is therefore very important and urgent for industries and academic institutions to develop a replacement for these kinds of the HFCs.

In order to achieve a similar effect to the HFC coatings, an amphiphobic monolayer—with hydrophobic and oleophobic properties—needs to be formed on the OTM surfaces. A fingerprint contains water and oil, so hydrophobic properties alone are insufficient to provide anti-fingerprint properties. Therefore, oleophobic compounds are needed for anti-fingerprint properties in addition to the hydrophobic properties. On the surface of OTMs, there are abundant hydroxy groups which can be used to bond the hydrophobic and oleophobic monolayer.

Silane, siloxane (or a combination of the two) are non-fluorinated compounds which can easily bind with the hydroxy groups, and which provide both hydrophobic and oleophobic properties for this purpose. In contrast to HFCs, however, non-fluorinated compounds such as siloxanes and silanes provide varying levels of hydrophobic and oleophobic properties. For example, some can only provide hydrophobic effects above a molecular weight of approximately 150. Furthermore, a silane, siloxane or combination of the two does not provide oleophobic properties in all cases. For example, when the carbon of a silane is too short, such as isobutyl silane, the hydrophobic property is lost.

Emulsion-based siloxane coatings are often used on these optical transparent materials today. There are a variety of emulsions available at reasonable costs. However, the adhesion of emulsion coatings to the OTMs is often insufficient to meet the performance needs of many end-use applications because of the thickness of the coating. To mitigate this thickness issue, the emulsion is often diluted to a thin concentration to meet the requirement, resulting in a suitable layer.

Siloxane/silane compounds are siloxane/silicon-based materials which can bond with many OTM materials to promote adhesion, including those mentioned above, as well as various inorganic or organic materials. A silane contains four functional groups, which can provide different functions; for example, a halogen group such as, fluorine, chlorine; bromine groups; an ether group such as methoxy, ethoxy, etc.; an alkyl group such as methyl, ethyl, octyl, cyclohexyl; hexadecyl groups; and coupling agent groups such as glycidyloxypropyl, epoxycyclohexylethyl, etc. Normally, different groups on the silane act provide different functions. Silanes containing halogen and alkyoxy groups easily react with surfaces that contain hydroxy groups. Normally the reactivity is: halogen>methoxy>ethoxy. The other groups of a siloxane/silane compound can act as an adhesive coupling agent or hydrophobic agent; for example, the amine, glycidyloxypropyl and epoxycyclohexylethyl, can act as a coupling agent. However, any alkyl groups can act as hydrophobic groups and provide anti-fingerprint properties. Normally, the bigger the alkyl groups, the more hydrophobic the compound. The monolayer coatings are also used to protect the surface from wear, scratches, chemicals, light, moisture and other environmental insults. The specific concentration of a siloxane/silane compound is also very important to form a monolayer applied via a spray or spin coating. If the siloxane/silane concentration is too high, the monolayer will not be formed; if the concentration of the siloxane/silane is too low, it is insufficient to form a monolayer. Finally, the thermal treatment of the siloxane/silane coating may be necessary for the reaction of the halogen and alkoxy groups on the OTM surface.

One type of coating is described in Canadian Patent Application No. 3,060,548, which describes a composition with an oleophobic layer and a polydimethylsiloxane resin layer. However, it did not significantly improve the hydrophobic and oleophobic properties of the coating in a meaningful way.

European Patent No. 3931269B1 also discloses an improved coating, but again fails to disclose a composition which is capable of achieving an optimal balance to maximize the oleophobic and hydrophobic properties without the traditional limitations.

Therefore, a new formulation of silane/siloxane chemistry and method of application is needed and necessary.

### SUMMARY

Embodiments described herein are directed to an improved hydrophobic and oleophobic compound and process for use in the coating of optical transparent materials (OTMs), wherein the compound comprises an organic solvent, a hydrophobic siloxane and/or silane agent, an oleophobic siloxane and/or silane agent with a hydrogen bond donor.

In one exemplary embodiment, a non-fluorinated hydrophobic and oleophobic coating compound comprises: approximately 80% to approximately 99.99% of an organic solvent containing at least one hydroxy group, such as methanol, ethanol, (iso)propanol, methoxyethanol, ethoxyethanol, ethylene glycol, and propylene glycol; 0.001% to 5.0% of at least one siloxane and/or silane hydrophobic agent having a molecular weight greater than approximately 150 and with an alkyl functional component; and 0.001% to 2.5% of at least one siloxane and/or silane oleophobic agent with an active hydrogen bond donor as a functional group, such as amine, glycidyl, epoxy, hydroxy and carboxy groups.

In another embodiment, a method of coating a surface with a non-fluorinated hydrophobic and oleophobic compound comprises the steps of: providing a hydrophobic and oleophobic coating compound comprising; 80% to 99.99% of organic solvent containing at least one hydroxy group as solvents with molecular weight less than 250; 0.001% to 5.0% of at least one siloxane/silane with alkyl functional component with an average molecular weight greater than 150, as hydrophobic agents; and 0.001% to 2.5% of at least one functional grouped siloxane/silane with active hydrogen bond donor; applying the hydrophobic and oleophobic coating compound onto an optical transparent material (OTM) substrate; and thermally curing the OTMs substrate coated with the hydrophobic and oleophobic coating compound to a temperature from approximately 50 degrees Celsius to approximately 175 degrees Celsius for approximately 10 minutes to approximately 2 hours.

Additional aspects related to the invention will be set forth in part in the description which follows, and in part will be apparent from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### DETAILED DESCRIPTION

In the following detailed description, reference will be made to numerous embodiments and aspects of the invention. These implementations are described in sufficient detail to enable those skilled in the art to practice the invention, and it is to be understood that other implementations may be utilized and that structural changes and/or substitutions of various elements may be made without departing from the scope and spirit of present invention. The following detailed description is, therefore, not to be construed in a limited sense.

In the process of developing the inventive subject matter outlined below, it was found that the high molecular weight of a siloxane emulsion can provide very good hydrophobicity; however, it is hard to dissolve and/or emulsify into organic solvents with high molecular weights. Additionally, a siloxane and/or silane composition with alkyloxy groups is hard to keep stable in water because the alkyloxy group will hydrolyze in the aqueous phase. Only an alcohol anhydride as a solvent can keep the alkyloxy group on the siloxane and/or silane composition balanced. So, a small molecular weight alcohol, such as methanol, ethanol, (iso)propanol, methoxyethanol, ethoxyethanol, or ethylene glycol, can keep both a high molecular weight siloxane emulsion and a small molecular weight siloxane/silane stable, and provide both the hydrophobic and oleophobic properties. Furthermore, these types of alcohols also keep the crosslinker functional grouped siloxane and/or silane with an amine, glycidyl, epoxy, hydroxy and carboxy groups stable.

A coating such as that described above and in further detail below was found to achieve a high number on a 1.0 kg scratch resistance test on a 1 cm×1 cm steel wool rubbering, as shown in the examples provided below and in Table 1.

### Solvent

In one embodiment, any conventional alcohol solvents typically found in siloxane/silane compounds can be used in compounds of the instant invention, including methanol, ethanol, (iso)propanol, methoxyethanol, ethoxyethanol, ethylene glycol, and propylene glycol. Other additives as known to those skilled in the art may also be used, including water. In another embodiment, the solvent has a molecular weight of less than approximately 250 to provide for adequate evaporation.

Hydrophobic Agent: Siloxane/Silane with Alkyl Functional Group

In one embodiment, a siloxane and/or silane composition with an alkyl functional group can provide hydrophobic properties. As the number of alkyl carbon groups increase, the hydrophobic properties increase as well. When the number of alkyl carbon groups reach approximately ten or above, the water contact angle can reach about 95 degrees (where 90 degrees is the standard threshold to determine if a surface is hydrophobic).

Suitable non-limiting examples of siloxane/silane compositions with alkyl functional grouped components contemplated for use in the instant invention include, but are not limited to:
1,8-BIS(TRIETHOXYSILYL)OCTANE;
1,6-BIS(TRIMETHOXYSILYL)HEXANE;
1,2-BIS(TRIMETHOXYSILYL)DECANE;
ISOOCTYLTRIMETHOXYSILANE;
n-OCTADECYLDIMETHYLCHLOROSILANE;
HEXADECYLTRIETHOXYSILANE;
n-OCTADECYLDIMETHYLCHLOROSILANE;
DODECYLMETHYLDICHLOROSILANE;
n-OCTYLDIMETHYLMETHOXYSILANE;
n-OCTADECYLDIMETHYLMETHOXYSILANE;
n-OCTYLDIMETHYLCHLOROSILANE;
n-DECYLTRIETHOXYSILANE;
n-OCTADECYLMETHYLDICHLOROSILANE;
n-OCTADECYLTRIMETHOXYSILANE;
n-OCTADECYLDIMETHYLCHLOROSILANE;
n-OCTYLSILANE;
n-OCTADECYLTRICHLOROSILANE;
CYCLOHEXYLTRICHLOROSILANE;
n-DECYLDIMETHYLCHLOROSILANE;
n-DECYLTRICHLOROSILANE;
n-OCTYLTRIMETHOXYSILANE;
n-OCTADECYLTRICHLOROSILANE;
n-OCTYLTRICHLOROSILANE;
ISOOCTYLTRIETHOXYSILANE;
ADAMANTYLETHYLTRICHLOROSILANE;
ADAMANTYLETHYLTRImethoxy (or triethoxySILANE);
HEXADECYLTRIMETHOXYSILANE;
DODECYLDIMETHYLCHLOROSILANE;
n-OCTYLTRIETHOXYSILANE;
n-OCTADECYLDIMETHYLSILANE;
[(5-BICYCLO[2.2.1]HEPT-2-ENYL)ETHYL]TRIMETHOXYSILANE;
[(5-BICYCLO[2.2.1]HEPT-2-ENYL)ETHYL]TRIETHOXYSILANE;
DOCOSENYLTRIETHOXYSILANE;
11-(2-METHOXYETHOXY)UNDECYLTRICHLOROSILANE;
METHYLHYDROSILOXANE-DIMETHYLSILOXANE COPOLYMER, TRIMETHYLSILOXANE TERMINATED;
13-(TRICHLOROSILYLMETHYL)HEPTACOSANE;
7-(TRICHLOROSILYLMETHYL)PENTADECANE;
OCTADECYLDIISOBUTYLCHLOROSILANE;
DODECYLTRIMETHOXYSILANE;
TRIACONTYLDIMETHYLCHLOROSILANE;
TRIACONTYLTRICHLOROSILANE;
n-OCTADECYLMETHYLDICHLOROSILANE;
SILICLAD;
N-[3-(TRIMETHOXYSILYL)PROPYL]HEXADECANAMIDE;
POLYOCTYLMETHYLSILOXANE;
(ETHYLMETHYLSILOXANE)-(2-PHENYLPROPYLMETHYLSILOXANE) COPOLYMER;
(HEXYLMETHYLSILOXANE)-(2-PHENYLPROPYLMETHYLSILOXANE) COPOLYMER;
POLYDIETHYLSILOXANE, TRIETHYLSILOXY TERMINATED;
HYDRIDE TERMINATED POLYDIMETHYLSILOXANE;
POLYDIMETHYLSILOXANE, TRIMETHYLSILOXY TERMINATED;
POLYPHENYL-(DIMETHYLHYDROSILOXY)SILOXANE, HYDRIDE TERMINATED;
(6-7% METHYLHYDROSILOXANE)-DIMETHYLSILOXANE COPOLYMER, TRIMETHYLSILOXANE TERMINATED;
POLYMETHYLHYDROSILOXANE, TRIMETHYLSILYL TERMINATED; and
MONOHYDRIDE TERMINATED POLYDIMETHYLSILOXANE.
   Oleophobic Agent: Siloxane/Silane Emulsion with Hydrogen Donor

In one embodiment, a siloxane and/or silane emulsion can provide oleophobic properties. In order to provide sufficient oleophobic properties, a part of the functional component needs to have a hydrogen donor, which is typically an —H group, and more specifically an —NH group. However, the siloxane and/or silane emulsion also needs to be stable in a basic environment. Therefore, in one embodiment the ammoniation of the silane/siloxane emulsion is needed. After the addition of at least one hydrogen group, the oil contact angle can reach about 35 degrees.

Suitable non-limiting examples of ammonization of silane/siloxane for the hydrophobic and oleophobic composition include:
(AMINOPROPYLMETHYLSILOXANE)-DIMETHYLSILOXANE COPOLYMER;
(AMINOETHYLAMINOPROPYLMETHYLSILOXANE)-DIMETHYLSILOXANE COPOLYMER;
(AMINOETHYLAMINOPROPYLMETHOXYSILOXANE)-DIMETHYLSILOXANE COPOLYMER WITH BRANCH STRUCTURE;
AMINOPROPYL TERMINATED POLYDIMETHYLSILOXANE; N-ETHYLAMINOISOBUTYL TERMINATED POLYDIMETHYLSILOXANE;
monoAMINOPROPYL TERMINATED POLYDIMETHYLSILOXANE;
1-[3-(2-AMINOETHYL)-3-AMINOISOBUTYL]-1,1,3,3,3-PENTAETHOXY-1,3-DISILAPROPANE;
(AMINOETHYLAMINOMETHYL)PHENETHYLTRIMETHOXY(or ethoxy)SILANE;
N-(2-AMINOETHYL)-3-AMINOPROPYLTRIETHOXY(oe methoxy)SILANE;
N-(2-AMINOETHYL)-3-AMINOPROPYLTRIMETHOXY(or ethoxy)SILANE;
N-(2-AMINOETHYL)-3-AMINOPROPYLTRIMETHOXY(or ethoxy)SILANE-PROPYLTRIMETHOXY(or ethoxy)SILANE;
N-(6-AMINOHEXYL)AMINOMETHYLTRIETHOXY (or methoxy) SILANE;
N-(2-AMINOETHYL)-11-AMINOUNDECYLTRIMETHOXY(ethoxy)SILANE;
3-(m-AMINOPHENOXY)PROPYLTRIMETHOXY(or methoxy)SILANE;
3-AMINOPROPYLDIISOPROPYLETHOXY(or methoxy)SILANE;
3-AMINOPROPYLDIMETHYLETHOXY(or methoxy)SILANE;
3-AMINOPROPYLMETHYLBIS(TRIMETHYLSILOXY)SILANE;
3-AMINOPROPYLMETHYLDIETHOXY(or methoxy)SILANE;
3-AMINOPROPYLMETHYLDIETHOXY(or methoxy)SILANE;
3-AMINOPROPYLTRIS(TRIMETHYL(or ethoxy)SILOXY)SILANE;
1,3-BIS(3-AMINOPROPYL)TETRAMETHYLDISILOXANE;
BIS(3-TRIETHOXY(or methoxy)SILYLPROPYL)AMINE;
N,N′-BIS[(3-TRIMETHOXY(or methoxy)SILYL)PROPYL]ETHYLENEDIAMINE;
n-BUTYLAMINOPROPYLTRIMETHOXY(or ethoxy)SILANE;
(CYCLOHEXYLAMINOMETHYL)TRIETHOXYSILANE;
(3-(N-ETHYLAMINO)ISOBUTYL)TRIMETHOXY(or ethoxy) SILANE; and
N-METHYLAMINOPROPYLTRIMETHOXY(or ethoxy)SILANE;
(3-TRIMETHOXY(or ethoxy)SILYLPROPYL)DIETHYLENETRIAMINE.

In one embodiment, in order to enhance the oleophobic properties, one or more hydrophilic compounds may be added in to coating compound, such as:
UREIDOPROPYLTRIMETHOXYSILANE; or
TETRAKIS(TRIMETHYLSILOXY)TITANIUM.

### Crosslinker

In some embodiments, in order to enhance the scratch resistance properties of the coating, one or more crosslinkers may be added to the compound. In one example, the crosslinker may be TRIS(3-TRIMETHOXY(or ethoxy) SILYLPROPYL)ISOCYANURATE.

### Methods of Application

The hydrophobic and oleophobic coating compound may be applied to OTM substrates to create a monolayer in a variety of ways, e.g., by spray coating, spinning, or dipping coating, curtain coating, ink jetting, flexographic printing, and the like. These techniques can be readily carried out by those skilled in the art. In one embodiment, the thickness of the monolayer can range from less than approximately 10 nanometers to approximately 1 millimeter and still achieve the desired hydrophobic and oleophobic effects. However, as the thickness increases, the opacity and transparency of the coating may be reduced, which may have drawbacks for certain applications on eyeglasses or smartphones where the display underneath the coating must be clearly visible. In other applications where the complete visibility of the underlying OTM surface is less necessary, and where improved durability of the coating is preferable (such as on countertops, concrete, etc.), a thicker coating may be applied. Thus, a coating for a glass surface on a smartphone may only have a thickness of approximately 10 nm, while a coating applied to a countertop or an article of clothing may have a thickness of approximately 1 mm.

In one embodiment, before an alkyl siloxane/silane monolayer can be created on the surface of an OTM, the surface of the OTM may be pre-treated using a deep UV, laser, plasma, ozone and the like. The pretreatment will help achieve a better coating effect by cleaning the surface to remove contaminants and polarizing the surface to increase adhesion of the coating. One option for pre-treatment includes wetting the surface to obtain a uniform surface coating.

After the coating compound is applied to the OTM surface, it may need to be cured. In one embodiment, the curing treatments may include radiation, thermal, and electronic beam applications. In spite of these extra process steps, however, the strength of the treatments needs to be controlled.

In one embodiment, the hydrophobic and oleophobic coating is cured by thermal treatment for approximately 10-120 minutes with dry, heated air. For curing to occur, the temperature needs to be 50° C. to approximately 175° C., where higher temperatures require less time (and vice versa). In one embodiment, higher temperature doses over shorter periods of time are preferred.

The coatings of this invention can be cured in ambient air or under a gas environment such as nitrogen, argon, helium or similar, including blends thereof. The atmosphere used during the curing step can be at full atmospheric pressure or reduced pressure, which will then reduce the curing time.

Suitable non-limiting examples of OTM substrates for use with this invention include inorganic materials such as glass, quartz, sapphire, etc., and organic materials such as polycarbonates, polyurethanes, CR-39, Trivex, fabrics, etc. The inventive coating may be widely used for products such as eyeglass lenses, phones, vehicles, and building, construction and decorative materials such as countertops, concrete, windows, etc.

### Properties on Coated Substrates

The properties of the hydrophobic and oleophobic coating as applied on glass after curing were tested by determining an initial water contact angle and oil contact angle of a Hexadecane drop using a Rame-Hart Goniometer with a 0.5 mm needle diameter. The samples were also tested to determine the water contact angle after administering a steel wool abrasion test on a 1 cm×1 cm area with 1000 grams of load at 60 cycles/minute. The samples were also tested to determine the water contact angle after a rubber test on a 0.6 cm diameter area with 1000 grams of load at 60 cycles/minute. Finally, the samples were tested to determine the water contact angle after being exposed to boiling water for 2 hours, and after being exposed to mustard for a week. The results of the tests are provided in Table 1, below.

Embodiments of the invention will now be described in detail by reference to the following non-limiting examples and their resulting properties in Table 1.

### Example 1

In a first example of a non-fluorinated compound, in approximately 100 ml of deionized (DI) water, approximately 0.115 grams of aminofunctional polydimethylsiloxane dio (Silres® BS 1360, Wacker Chemical Corporation, Ann Arbor, MI), approximately 0.405 grams of polyacrylate siloxane (Silres® BS 6510, Wacker Chemical Corporation, Ann Arbor, MI), and approximately 0.05 grams of octyltriethoxysilane (Silquest™ A-137, Momentive Performance Materials, Inc., Niskayuna, NY) were combined and stirred thoroughly. The compound was then spray coated on a slide of glass which was pretreated with a 185 nm deep UV light with an intensity of 1500 mJ/cm². The deposited coating was then cured by cooking at approximately 160° C. for approximately 15 min. Multiple tests were then conducted on the coating to determine the hydrophobic and oleophobic properties, as indicated in Example 1 in Table 1.

### Example 2

In a second example of a non-fluorinated compound, in approximately 100 ml of DI water, approximately 0.123 gram of aminofunctional polydimethylsiloxane dio (Silres® BS 1360, Wacker Chemical Corporation, Ann Arbor, MI), approximately 0.403 gram of polyacrylate siloxane (Silres® BS 6510), approximately 0.042 gram of hexadecyltrimethoxysilane (Dynasylan® 9116, Evonik Industries, Essen, Germany), and approximately 0.086 gram of aminopropyltrimethoxysilane (Dynasylan® AMMO, Evonik Industries, Essen, Germany) were combined and stirred thoroughly. The compound was then spray coated on a slide of glass, which was pretreated with a 185 nm deep UV light with an intensity of 1500 mJ/cm². The deposited coating was then cured by cooking at approximately 160° C. for approximately 15 min. Multiple tests were then conducted on the coating to determine the hydrophobic and oleophobic properties, as indicated in Example 2 of Table 1.

### Example 3

In a third example of a non-fluorinated compound, in 100 ml of ethanol anhydride, approximately 0.030 grams of tris(3-(trimethoxysilyl)propyl)isocyanurate (Silquest™ A-link 597, Momentive Performance Materials, Inc., Niskayuna, NY), approximately 0.051 grams of aliphatic fatty acid-modified anionic polyurethane emulsion (Bayhydrol® UH 2593/1, Covestro, LLC, Pittsburgh, PA), approximately 0.168 grams of alkoxy terminated amino alkyl functional siloxane (Silres® BS 30A, Wacker Chemical Corporation, Ann Arbor, MI), and approximately 0.251 grams of di-me(((3-aminopropyl)silylidyne)tris(oxy)trisilane/siloxane (Evonik Tego® Phobe 1409, Evonik Industries, Essen, Germany) were combined and stirred thoroughly. The compound was then spray coated on a slide of glass which was pretreated with a 185 nm deep UV light with an intensity of 1500 mJ/cm². The deposition was then cured by cooking at approximately 160° C. for approximately 15 min. Multiple tests were then conducted on the coating to determine the hydrophobic and oleophobic properties, as indicated in Example 3 of Table 1.

### Example 4

In a third example of a non-fluorinated compound, in a 100 ml of ethanol anhydride, approximately 0.0375 grams of aminopropyltrimethoxysilane (Dynasylan® AMMO, Evonik Industries, Essen, Germany), approximately 0.175 grams of alkoxy terminated amino alkyl functional siloxane mixed with silane (Silres® BS 290), and approximately 0.0375 grams of di-me(((3-aminopropyl)silylidyne)tris(oxy)trisilane/siloxane (Evonik Tego® Phobe 1409) were combined and stirred thoroughly. The compound was then spray coated on a slide of glass which was pretreated with a 185 nm deep UV light with an intensity of 1500 mJ/cm². The deposition was then cured by cooking at approximately 160° C. for 15 min. Multiple tests were then conducted on the coating to determine the hydrophobic and oleophobic properties, as indicated in Example 4 of Table 1.

### Table 1: Properties of Example Compounds

Table 1 indicates how the different compounds provide minor variations in the hydrophobic and oleophobic properties of the coating, as measured by the water contact angle (to measure hydrophobicity) and oil contact angle (to measure oleophobicity). The set of initial tests also measured the durability of the hydrophobic properties after various exposures including boiling in water, mustard soak testing for approximately one week, and a rubber cycle fatigue test. A second set of durability tests were performed to measure the water contact angle after several different cycles of steel wool abrasion.

TABLE 1

| | | Exam- | Exam- | Exam- | Exam- |
|---|---|---|---|---|---|
| Properties | | ple 1 | ple 2 | ple 3 | ple 4 |
| Initial | Water contact angle @ | 110° | 107° | 102° | 105° |
| tests | 25° C. | | | | |
| | Oil contact angle @ | 34° | 40° | 30° | 35° |
| | 25° C. | | | | |
| | Water contact angle @ | 107° | 107° | 102° | 105° |
| | 25° C. After 100° C. | | | | |
| | boiled water for 1 hr | | | | |
| | Water contact angle @ | 107° | 107° | 102° | 105° |
| | 25° C. After mustard | | | | |
| | soak for 1 week | | | | |
| | Water contact angle @ | 70° | 75° | 75° | 80° |
| | 25° C. After 100 | | | | |
| | Rubber cycles | | | | |
| | Appearance | cloudy | patterns | clear | clear |
| After 200 | Water contact angle @ | 70° | 75° | 75° | 80° |
| steel wool | 25° C. | | | | |
| cycles | | | | | |
| After 1000 | Water contact angle @ | 60° | 60° | 63° | 65° |
| steel wool | 25° C. | | | | |
| cycles | | | | | |
| After 2000 | Water contact angle @ | 55° | 55° | 60° | 60° |
| steel wool | 25° C. | | | | |
| cycles | | | | | |

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description presented herein represents a presently preferred embodiment of the invention and is therefore representative of the subject matter which is broadly contemplated by the present invention. It is further understood that the scope of the present invention fully encompasses other embodiments that may become obvious to those skilled in the art and that the scope of the present invention is accordingly not limited.

1. A non-fluorinated hydrophobic and oleophobic composition for coating a substrate, said composition comprising:
an organic solvent with at least one hydroxy group;
a hydrophobic compound comprising at least one siloxane and/or silane with an alkyl functional component; and
an oleophobic compound comprising at least one siloxane and/or silane with an active hydrogen bond donor.

2. The compound of claim 1, wherein the hydroxy group-containing solvent has a molecular weight of less than approximately 250.

3. The compound of claim 1, wherein the hydroxy group-containing solvent is selected from a group consisting of: methanol, ethanol, (iso)propanol, methoxyethanol, ethoxyethanol, ethylene glycol, and propylene glycol.

4. The compound of claim 3, wherein said at least one hydroxy group-containing solvent with a molecular weight less than 250 is methanol or ethanol, or the mixture of the forgoing.

5. The compound of claim 1, wherein the organic solvent represents approximately 80% to approximately 99.99% of the compound by weight.

6. The hydrophobic compound of claim 1, wherein the siloxane/silane has an average molecular weight of greater than approximately 150.

7. The composition of claim 1, wherein the hydrophobic compound represents approximately 0.001% to approximately 5.0% of the composition by weight.

8. The composition of claim 1, wherein the oleophobic compound represents approximately 0.001% to approximately 2.5% of the composition by weight.

9. The compound of claim 1, wherein the oleophobic compound comprises an active hydrogen bond donor.

10. The compound of claim 1, wherein the solvent is a wetting agent.

11. A oleophobic compound according to claim 9, further comprising at least one additional component selected from the group consisting of crosslinkers, wetting agents and stabilizers and combinations of the foregoing.

12. A method of applying a hydrophobic and oleophobic coating to a substrate, the method comprising the steps of:
providing a hydrophobic and oleophobic coating composition, the composition comprising:
approximately 80% to 99.99% by weight of organic solvent containing at least one hydroxy group;
approximately 0.001% to 5.0% by weight of at least one siloxane/silane compound with an alkyl functional component, as a hydrophobic agent; and
approximately 0.001% to 2.5% by weight of at least one siloxane and/or silane with an active hydrogen bond donor, as an oleophobic compound; and
applying the coating onto the substrate; and
thermally curing the coating with temperatures from approximately 50 degrees Celsius to 175 degrees Celsius for approximately 10 minutes to approximately 2 hours.

13. The method of claim 12, further comprising applying the compound using thermal curing.

14. The method of claim 12, wherein the organic solvent has a molecular weight approximately less than 250, and wherein the organic solvent is selected from the group consisting of: methanol, ethanol, ethylene glycol, propylene glycol, (iso)propanol, methoxyethanol, ethoxyethanol, and mixtures of the foregoing.

15. The method of claim 14, wherein the at least one hydroxy group-containing solvent is methanol or ethanol.

16. The method of claim 12, further comprising selecting the at least one hydrophobic agent with an average molecular weight greater than 150.

17. The method of claim 16, further comprising selecting the at least one hydrophobic agent from a group consisting of C-12, alkyl groups >C-12, or an alkoxy terminated animo-alkyl (>C12) functional siloxane/silane.

18. The method of claim 12, wherein the siloxane/silane with an active hydrogen donor is an amine-functionalized siloxane/silane.

19. The method of claim 12, further comprising selecting di-Me, [[(3-aminopropyl)silylidyne]tris(oxy)]tris trisilane/siloxane emulsion as said at least one oleophobic compound.

20. The method according to claim 12, further comprising providing at least one additional compound from the group consisting of crosslinkers, wetting agents and stabilizers.
